(19) United States
(12) Patent Application Publication
(10) Pub. No.: US 2009/0123651 A1
(43) Pub. Date: May 14, 2009

(54) Continuous Annealing and Hot Dip Plating Method and Continuous Annealing and Hot Dip Plating System of Steel sheet Containing Si

(76) Inventor: Nobuyoshi Okada, Chiba (JP)

Correspondence Address: KENYON & KENYON LLP, ONE BROADWAY, NEW YORK, NY, 10004, US

(21) Appl. No.: 12/083,396

(22) PCT Filed: Sep. 6, 2006
(86) PCT No.: PCT/JP2006/318089

§ 371 Date: Apr. 9, 2008

(30) Foreign Application Priority Data
Oct. 14, 2005 (JP) 2005-299915

(51) Int. Cl. B05D 1/18; B05C 11/00

(52) U.S. Cl. 427/319; 118/68

(57) ABSTRACT

The present invention provides, in a hot dip plating system having an annealing furnace for hot dip plating steel sheet containing Si, a continuous annealing and hot dip plating method and system causing internal oxidation without causing surface oxidation of the Si in the steel and avoiding a drop in the plating ability of the steel sheet and retardation of alloying, that is, a continuous annealing and hot dip plating method using an annealing furnace having, in order, a front heating zone, rear heating zone, soaking zone, and cooling zone and a hot dip plating bath, comprising heating or soaking the steel sheet at a steel sheet temperature of a temperature range of at least 300° C. or more by indirect heating, making an atmosphere of the zones one comprised of hydrogen H: 1 to 10 vol % and a balance of nitrogen and unavoidable impurities, making a steel sheet peak temperature during heating at the front heating zone 550 to 750° C. and making the dew point less than −25° C., making dew points of the following rear heating zone and soaking zone −30° C. to 0° C., and making a dew point of the cooling zone less than −25° C.

### TECHNICAL FIELD

The present invention relates to a continuous annealing and hot dip plating method and continuous annealing and hot dip plating system for steel sheet containing Si.

Note that the hot dip plating in the present invention does not particularly specify the type of the plating metal and includes hot dip plating of zinc, aluminum, tin, or other metals and their alloys.

### BACKGROUND ART

When hot dip plating steel sheet with zinc, aluminum, tin, or another metal or their alloys, usually the surface of the steel sheet surface is degreased and cleaned, then the steel sheet is annealed by an annealing furnace, the steel sheet surface is activated by hydrogen reduction, the sheet is cooled to a predetermined temperature, then the sheet is dipped in a hot dip plating bath. With this method, when the components of the steel sheet include Si, Mn, and other easily oxidizable metals, during the annealing, these easily oxidizable elements form single or composite oxides at the steel sheet surface, obstruct the plating ability, and cause nonplating defects. Alternatively, when plating, then reheating for alloying, the alloying rate is lowered. Among these, Si forms an SiO₂ oxide film on the steel sheet surface to remarkably lower the steel sheet and hot dip plating metal wettability. Simultaneously, the SiO₂ oxide film forms a large barrier to diffusion between the iron metal and the plating metal at the time of alloying. Therefore, this is particularly a problem. To avoid this problem, it is sufficient to sharply lower the oxygen potential in the annealing atmosphere, but industrially obtaining an atmosphere in which Si, Mn, etc. will not oxidize is de facto impossible.

To deal with this problem, Japanese Patent No. 2,618,308 and Japanese Patent No. 2,648,772 disclose a method of using a direct-fired heating furnace arranged in front of the annealing furnace to form an Fe oxide film at a thickness of 100 nm or more, then control the subsequent indirect heating furnace and on so that the previously formed Fe oxide film is reduced right before dipping in the plating bath and as a result prevent the formation of oxides of Si, Mn, and other easily oxidizable metals.

Further, Japanese Unexamined Patent Publication No. 2000-309824 discloses a method of production of hot dip plated steel sheet by heat treating hot rolled steel sheet with the black scale as deposited at 650° C. to 950° C. to cause the easily oxidizable elements to internally oxidized, then pickling, cold rolling, and hot dip plating it.

Further, Japanese Unexamined Patent Publication No. 2004-315960 discloses a method of adjusting the atmosphere in an annealing furnace of a hot dip plating system to cause the Si or Mn to be internally oxidized and thereby avoid the detrimental effects of these oxides.

However, these prior arts have the following problems.

Japanese Patent No. 2,618,308 and Japanese Patent No. 2,648,772 disclose methods finishing the reduction of Fe-based oxide films formed by a direct-fired heating furnace right before dipping in a hot dip plating bath. If the oxide films are insufficiently reduced, conversely a drop in the plating ability is induced. Further, if the oxide films are reduced too early, Si, Mn, and other surface oxides will form. Therefore, extremely sophisticated control of the furnace operation is necessary, so these methods lack industrial stability. Further, oxide films formed by a direct-fired heating furnace will peel off from the steel sheet and deposit on the roll surfaces while the steel sheet is being wound around the rolls in the furnace, so will form impression defects in the steel sheet. For this reason, recently, from the viewpoint of securing the quality of the steel sheet, rather than a direct-fired heating system, an indirect heating hot dip plating system has been becoming the mainstream. This technology cannot be used for an indirect heating hot dip plating system.

Japanese Unexamined Patent Publication No. 2000-309824 disclose the method of heat treating the steel sheet at the hot rolled stage to cause the harmful Si, Mn, etc. to internally oxidize and render them harmless, but the number of steps increases compared with the usual process of production of hot dip plated steel sheet, so the production costs unavoidably rise.

Japanese Unexamined Patent Publication No. 2004-315960 avoids the above problem, can be applied to an indirect heating hot dip plating system, and does not particularly increase the number of steps. However, the atmospheric conditions in an annealing furnace for causing Si or Mn to internally oxidize are also the conditions where surface oxidation of the iron metal occurs in the relatively low steel sheet temperature region, so unless defining the method of adjustment of the atmosphere in the annealing furnace, hearth roll defects are liable to be caused by the iron metal surface oxide film formed at the low temperature range. Industrially, special measures are required in the control of the atmosphere.

### DISCLOSURE OF THE INVENTION

Therefore, an object of the present invention is to provide a system and method for hot dip plating steel sheet containing Si by an indirect heating system during which preventing the formation of surface oxides of the iron metal in the relatively low temperature range and causing the Si or Mn to internally oxidize and thereby avoid a drop in the plating ability of the steel sheet and retardation in alloying.

The present invention was made to solve the above problem and has as its gist the following.

(1) A continuous annealing and hot dip plating method for steel sheet containing Si using an annealing furnace having, in order in a direction of conveyance of steel sheet, a front heating zone, rear heating zone, soaking zone, and cooling zone and a hot dip plating bath provided at a rear of the same so as to continuously convey steel sheet to the annealing furnace and hot dip plating bath and continuously anneal and hot dip plate it, the continuous annealing and hot dip plating method characterized by heating or soaking the steel sheet at a steel sheet temperature of a temperature range of at least 300° C. or more by indirect heating, making an atmosphere of the front heating zone, rear heating zone, soaking zone, and cooling zone one comprised of hydrogen in an amount of 1 to 10 vol % and a balance of nitrogen and unavoidable impurities, making a dew point of the front heating zone less than −25° C., making dew points of the rear heating zone and soaking zone −30° C. to 0° C., making a dew point of the cooling zone less than −25° C., annealing with a steel sheet peak temperature during heating in the front heating zone 550 to 750° C., then hot dip plating the sheet.

(2) A continuous annealing and hot dip plating method for steel sheet containing Si as set forth in (1), characterized by exhausting at least part of the atmospheric gas flowing from the front heating zone to the rear heating zone side between the front heating zone and the rear heating zone.

(3) A continuous annealing and hot dip plating method for steel sheet containing Si as set forth in (2), characterized by sealing the atmosphere between the front heating zone and the atmospheric gas exhaust location.

(4) A continuous annealing and hot dip plating method for steel sheet containing Si as set forth in any one of (1) to (3), characterized by sealing the atmosphere between the soaking zone and the cooling zone.

(5) A continuous annealing and hot dip plating method for steel sheet containing Si as set forth in any one of (1) to (4), characterized by wetting and introducing a mixed gas of nitrogen and hydrogen to the rear heating zone and/or the soaking zone.

(6) A continuous annealing and hot dip plating method for steel sheet containing Si as set forth in any one of (1) to (5), characterized by hot dip plating the steel sheet, then reheating it to 460° C. or more to cause the plating layer to alloy with the iron metal.

(7) A continuous annealing and hot dip plating system for steel sheet containing Si provided with an annealing furnace and a hot dip plating bath, loading a continuous steel sheet from a front of an annealing furnace, moving it continuously inside the furnace to anneal it, then taking it out from the furnace and then continuously hot dip plating it by the hot dip plating bath at the rear of the annealing furnace, the continuous annealing and hot dip plating system characterized in that the annealing furnace is provided with, in a direction of conveyance of the steel sheet, zones divided into a front heating zone, a rear heating zone, a soaking zone, and a cooling zone, each zone is provided with rollers for conveying the steel sheet and openings for continuously conveying the steel sheet between the zones, each zone has means for controlling a composition of an atmospheric gas and a dew point of the atmosphere, the front heating zone, rear heating zone, and soaking zone have indirect heating type steel sheet heating means, the front heating zone and rear heating zone have between them an atmospheric gas exhausting means for exhausting to the outside of the furnace at least part of the atmospheric gas flowing in from the front heating zone to the rear heating zone, and the atmospheric gas exhausting means and the front heating zone and/or the soaking zone and the cooling zone have between them an atmospheric gas sealing system.

(8) A continuous annealing and hot dip plating system for steel sheet containing Si as set forth in (7), characterized by being provided with an alloying furnace provided with a heating means for reheating the plated steel sheet at the rear of the hot dip plating bath.

According to the present invention, when heating steel sheet containing Si, the dew points of the heating zone and soaking zone are controlled to avoid the formation of Fe-based oxides at the steel sheet surface and the Si is made to internally oxidize so suppress the surface concentration of Si. Production of hot dip plated steel sheet superior in plating appearance and plating adhesion and production of alloyed hot dip plated steel sheet not requiring an extreme rise in the alloying temperature or a longer alloying time become possible.

### BRIEF DESCRIPTION OF THE DRAWINGS

FIG. 1 is a view illustrating a technique for forming internal oxides to avoid the formation of Fe-based oxides in the present invention.

FIG. 2 is a view of the overall configuration of a hot dip plating system of the present invention.

### BEST MODE FOR WORKING THE INVENTION

The Si, Mn, and other easily oxidizable elements contained in steel sheet form single or composite oxides at the steel sheet surface, that is, are externally oxidized, under the atmospheric conditions of the annealing furnace used for a usual hot dip plating system, so cause the formation of nonplating defects due to the drop in the plating ability and a drop in the alloying speed in the alloying treatment after plating. If causing the Si, Mn, and other easily oxidizable elements to form oxides inside the steel sheet, that is, to be internally oxidized, the majority of the steel sheet surface will be occupied by Fe, so a drop in the plating ability or a drop in the alloying speed can be avoided. Such Si, Mn, or other sole or composite internal oxides are formed by making the atmosphere of the annealing furnace one comprised of hydrogen in an amount of 1 to 10% and nitrogen in 99 to 90%, having a dew point of −30° C. to 0° C., and comprised of other unavoidable components and by heating the steel sheet to 550° C. or more. If the dew point is less than −30° C., the external oxidation of the Si, Mn, etc. is insufficiently suppressed and the plating ability falls. On the other hand, if the dew point exceeds 0° C., internal oxides are formed, but simultaneously the iron metal is oxidized, so the plating ability drops due to the poor reduction of the Fe-based oxides. When heating to 550° C. or more under atmospheric conditions suitable for the above internal oxidation, internal oxides are formed from the steel sheet surface down to 2 μm or less. If the internal oxides extend to a depth exceeding 2 μm from the steel sheet surface, due to heating at a high dew point under a high temperature for more than the necessary time etc., a large amount of internal oxides is formed. In this case, problems such as retardation of alloying arise.

In the case of an annealing furnace employing direct-fired heating for the front stage of heating, the atmosphere of the direct-fired heating zone is mainly comprised of the exhaust gas of combustion of the burner. Due to the larger amount of water vapor contained in the combustion exhaust gas, oxidation of the iron metal is inevitable and, as explained above, the steel sheet is liable to be formed with impression defects due to the hearth rolls. Therefore, for the region where the steel sheet temperature becomes 300° C. or more, where the steel sheet will substantially oxidize by a direct-fired heating system, an indirect heating system is suitably employed. However, the present invention does not concern itself with the heating method up to less than 300° C.

Si, Mn, etc. start to oxidize from the heating stage of the annealing, so the above atmospheric conditions suitable for internal oxidation should be made the heating zone and soaking zone of the annealing furnace. However, if the dew point in the atmosphere becomes −25° C. or more, Fe-based oxides will form on the steel sheet surface in the temperature range in the middle of the heating where the steel sheet temperature is relatively low. This type of oxide formed by the indirect heating system disappears in the later heating process, but remains even if the steel sheet temperature exceeds 550° C. In this case, the inventors discovered that it sticks to the rolls in the furnace and, like with the direct-fired heating system, causes impression defects on the steel sheet surface. To avoid this, the dew points at the front heating zone and cooling zone of the annealing furnace have to be made less than −25° C. to avoid the formation of Fe-based surface oxides and the atmosphere of the rear heating zone or soaking zone has to be made one of conditions suitable for the internal oxidation. The front heating zone should have a steel sheet peak temperature of 550° C. to 750° C. The lower limit temperature of the steel sheet peak temperature is made 550° C. because even if Fe-based oxides are formed at the steel sheet surface, if less than 550° C., there is substantially no problem of them sticking to the hearth rolls and causing impression defects in the steel sheet. On the other hand, the upper limit temperature of the steel sheet peak temperature was made 750° C. because if over 750° C., Si and Mn external oxides rapidly grow, so even if heating or soaking later in an atmosphere suitable for internal oxidation of Si or Mn and forming internal oxides, a good plating ability or alloying characteristics will no longer be able to be obtained.

Note that the highest peak temperature in the annealing furnace is usually over 750° C., but the suitable temperature differs depending on the targeted strength level or steel components, so this is not defined here. Further, the cooling temperature of the steel sheet in the cooling zone usually is about the same extent as the plating bath temperature, but the suitable temperature differs depending on the type of plating, so this is not defined here.

As the method for dividing the heating zone of an annealing furnace into front and rear zones, there is the method of providing a partition at a suitable position in the heating zone or separating the heating zone itself through a throat.

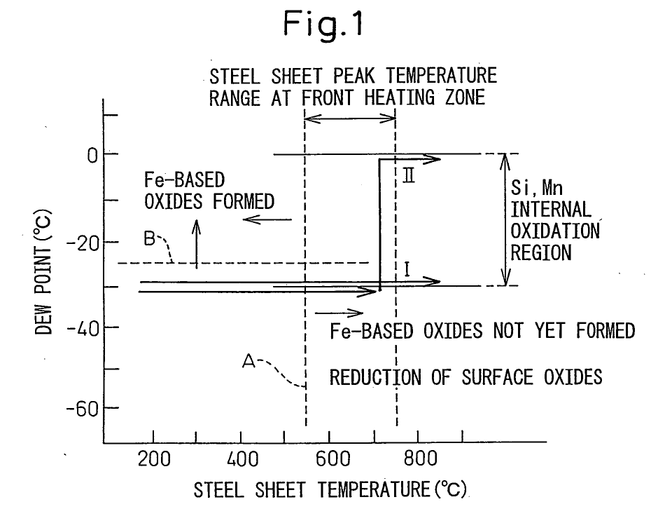

FIG. 1 illustrates the technique for forming internal oxides avoiding the formation of Fe-based oxides of the present invention explained above. A in the figure shows the limit of formation of Fe-based oxides and is near about 550° C. In a region of a temperature lower than this, Fe-based oxides are formed, while in a region of a temperature higher than this, Fe-based oxides are not formed and the Fe-based oxides formed at the low temperature side are reduced. B in the figure shows the upper limit of the dew point in the front heating zone according to the present invention and is near about −25° C. Further, I in the figure shows the steel sheet heating pattern suitable when forming internal oxides at the lowest dew point of the present invention. Further, II in the figure shows the steel sheet heating pattern suitable when forming internal oxides at the highest dew point of the present invention. In each case, in the heating region where the steel sheet temperature becomes 550° C. or more, no Fe-based oxides are formed.

Note that as the concentration of Si in the steel sheet for which this technology is effective, surface concentration of the Si causes the plating ability to drop creating a real problem at an Si concentration of 0.2 mass % or more. Further, if the Si concentration exceeds 2.5 mass %, the content of Si becomes too great and even if using this technology, it becomes hard to suppress surface concentration of the Si to a level not obstructing the plating ability. Therefore, a range of 0.2 to 2.5 mass % is preferable.

Regarding the amount of addition of Mn, the suitable amount differs depending on the targeted strength level or steel structure, so this is not defined here.

The atmospheric gas in the annealing furnace of the hot dip plating system usually flows from the plating bath side in the direction of the front heating zone. The majority is dispersed from the inlet of the heating zone to outside the furnace. Therefore, to separate the atmosphere, in particular the dew point, between the front and rear heating zones of the annealing furnace, the only option is to prevent the atmosphere of the high dew point soaking zone or rear heating zone from flowing into the front heating zone. There must be a system for exhausting part of the atmospheric gas flowing in from the rear heating zone to the front heating zone between the front and rear heating zones.

Further, to improve the effect of preventing the flow of atmospheric gas of the soaking zone or rear heating zone to the front heating zone, it is effective to have a system for system for exhausting part of the atmospheric gas flowing in from the rear heating zone to the front heating zone between the front and rear heating zones and further to have a sealing system for suppressing the outflow of atmospheric gas of the front heating zone and inflow of atmospheric gas of the rear heating zone at the front side of the exhaust system.

On the other hand, in the cooling zone at the rear from the heating zone or soaking zone, if the temperature of the steel sheet falls and the dew point becomes −25° C. or more, an Fe-based oxide film is liable to be formed again at the steel sheet surface. Therefore, to keep the atmospheric gas of the heating zone or soaking zone from flowing in reverse to the subsequent cooling zone and realize the effect of improvement of the plating ability and alloying characteristics due to formation of suitable internal oxides, provision of a sealing system between the heating zone or soaking zone and the cooling zone is necessary.

The atmosphere required for the effective formation of internal oxides is obtained by adjusting the flow rate of the usual nitrogen gas or hydrogen gas or mixed gas of the same to give the required composition and introducing it into the furnace and simultaneously introducing water vapor into the furnace. At this time, if directly introducing water vapor into the furnace, there will be the problem of deterioration of the uniformity of the dew point in the furnace and the problem that in the event of the high concentration water vapor directly contacting the steel sheet, useless oxides will be formed on the steel sheet surface, so the method of wetting and introducing nitrogen gas or a mixed gas of nitrogen and hydrogen is preferable. The nitrogen gas or mixed gas of nitrogen and hydrogen flowing into the furnace usually has a dew point of a low −40° C. or less, but the gas may be run through warm water or warm water may be sprayed against the gas flow or another method is used to obtain wet gas containing saturated water vapor close to the temperature of the warm water. The amount of moisture contained in the wet gas is much smaller than that of water vapor itself. When the gas is introduced into the furnace, there is the advantage that a more uniform atmosphere may be quickly formed compared with blowing in water vapor.

The atmosphere flowing in from the rear heating zone may be exhausted by for example a flow rate adjustment damper and an exhaust gas blower. Further, the sealing system installed at the front side of the exhaust gas system may be structured by for example a plurality of seal rolls, dampers, or baffle plates into which sealing use nitrogen is introduced. The sealing gas is partially exhausted by the exhaust system, but the atmosphere of the front heating zone is not exhausted much at all and the high dew point rear heating zone atmosphere can be kept from flowing into the front heating zone. The sealing system provided between the rear heating zone or soaking zone and the cooling zone may for example be structured in the same way as the sealing system provided at the front side of the exhaust gas system explained above, but the flow of gas in the annealing furnace is basically from the cooling zone side to the heating zone or soaking zone direction, so it is also possible not to introduce sealing use nitrogen.

The thus obtained steel sheet is hot dip plated, then may be reheated to a steel sheet temperature of 460° C. or more so as to cause the plating layer to alloy with the iron metal at a speed not causing problems industrially. An alloyed hot dip plated steel sheet containing Si which is free of nonplating defects can therefore be produced.

### EXAMPLES

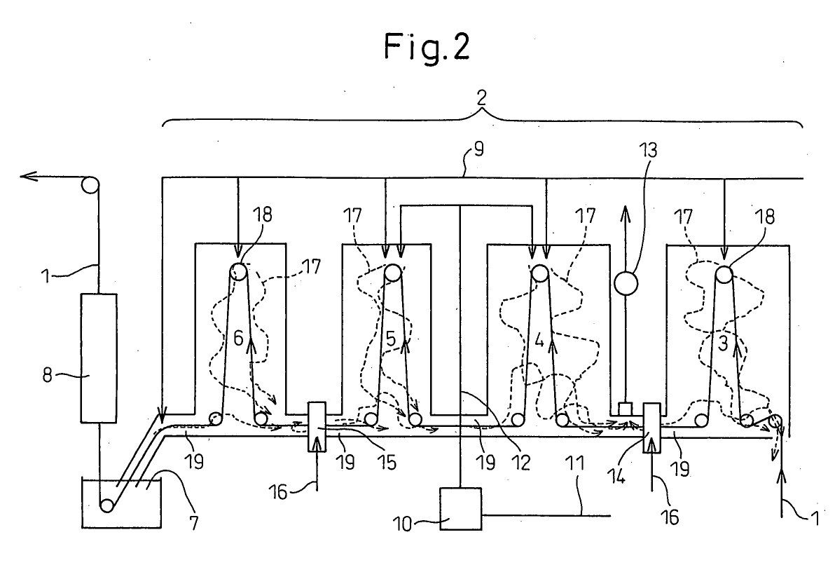

FIG. 2 shows an outline of one embodiment of a hot dip plating system of the present invention. In the present embodiment, the hot dip plating system is comprised of, in order in the conveyance direction of the steel sheet 1, an annealing furnace 2 having a front heating zone 3, a rear heating zone 4, a soaking zone 5, and a cooling zone 6, a hot dip plating bath 7, and an alloying system 8. The zones 3, 4, 5, and 6 of the annealing furnace are provided with rollers 18 for continuously conveying the steel sheet. Openings 19 are provided between the zones to enable the steel sheet to pass through the zones in the furnace. The zones in the annealing furnace 2 are connected to atmospheric gas pipes 9 for introducing atmospheric gas comprised of hydrogen and nitrogen. Wet nitrogen is obtained by blowing into nitrogen gas from a nitrogen pipe 11 to a nitrogen wetting system 10 and travels through a wet nitrogen feed pipe 12 to be introduced to the rear heating zone 4 and soaking zone 5. Between the front heating zone 3 and the rear heating zone 4, an exhaust system 13 and a front heating zone sealing system 14 are provided. Further, between the soaking zone 5 and the cooling zone 6, a cooling zone sealing system 15 is provided. These sealing systems are connected to sealing use nitrogen pipes 16. By configuring the system in this way, a flow of gas in the annealing furnace is formed as shown schematically by the atmospheric gas flow 17, so even if introducing wet nitrogen resulting in dew points in the rear heating zone and soaking zone of −30° C. or more, the flow of the high dew point atmosphere into the front heating zone or cooling zone is greatly suppressed and as a result the dew points of the front heating zone and cooling zone can be maintained at less than −25° C.

Next, an example of use of the hot dip plating system of the present embodiment to hot dip galvanize an Si-containing steel sheet, then reheat it to produce alloyed hot dip galvanized steel sheet will be explained.

For an experiment, a steel sheet of each of the components shown in Table 1 was used as the plating sheet. The atmosphere in the annealing furnace was pre-adjusted to hydrogen 5% and the balance of nitrogen and unavoidable components, then in accordance with the plating conditions, wet nitrogen was introduced and the exhaust system and sealing system were operated to control the dew points in the different zones to −40° C. to 5° C. in range. However, the dew point in the cooling zone was made −30° C. or less in all cases. As the annealing conditions, the steel sheet temperature at the exit side of the front heating zone was controlled to 400° C. to 780° C., the steel sheet temperature at the exit side of the rear heating zone was controlled to 830° C. to 850° C., and the steel sheet was held in the soaking zone for 75 seconds. Further, the steel sheet temperature at the exit side of the cooling zone was made 465° C. As the conditions of the plating bath, the bath temperature was made 460° C., the bath Al concentration was made 0.13%, and gas wiping was used to adjust the amount of plating deposition to 50 g/m² per side. As the alloying conditions, the alloying temperature was made 500° C. and the sheet was held there C for 30 seconds.

The presence of any oxidation of the steel sheet during the heating and soaking was detected by using a radiant thermometer using a polarization type detection element to measure the emissivity of the steel sheet surface. When a steel sheet has no surface oxidation, it exhibits an emissivity of 0.20 to 0.30 or so, but the emissivity exhibits a higher value in accordance with the extent of oxidation of the steel sheet surface. This time, an emissivity of 0.33 or more was judged as indicating surface oxidation of the steel sheet. Such radiant thermometers were provided at the exit of the front heating zone, the center of the rear heating zone, the exit of the rear heating zone, and the exit of the soaking zone.

The obtained plated steel sheet was evaluated for the presence of nonplating defects by inspection in the stopped state and for plating ability and alloying characteristics by measurement of the Fe concentration in the plating layer by sampling. Regarding the alloying characteristics, a plating layer having an Fe concentration of less than 8% is judged as not yet alloyed, while one over 12% is judged as being excessively alloyed. The other layers are judged to have passed.

The obtained results are as shown in Table 2. For all of the types of steel containing Si, by making the steel sheet temperature at the exit side of the front heating zone 550° C. to 750° C., making the dew point of the front heating zone less than −25° C., and making the dew points of the rear heating zone and soaking zone −30° C. to 0° C., surface oxidation of the steel sheet in the annealing furnace could be avoided and alloyed hot dip plated steel sheet with good plating ability and alloying characteristics could be obtained.

TABLE 1

| Steel | Steel components (mass %) | | | | | | | | |
|---|---|---|---|---|---|---|---|---|---|
| type | C | Si | Mn | P | S | Al | Ti | B | Ni |
| A | 0.004 | 0.3 | 1.2 | 0.060 | 0.006 | 0.050 | 0.09 | 0.003 | — |
| B | 0.1 | 0.5 | 1.6 | 0.008 | 0.003 | 0.025 | — | — | — |
| C | 0.1 | 1.25 | 1.6 | 0.007 | 0.005 | 0.25 | — | — | — |
| D | 0.12 | 1.2 | 1.1 | 0.009 | 0.007 | 0.32 | — | — | 0.6 |
| E | 0.11 | 1.8 | 1.58 | 0.008 | 0.003 | 0.30 | — | — | — |

TABLE 2

| | Front | Dew point | | | | | | |
|---|---|---|---|---|---|---|---|---|
| | heating | Front | Rear | | Steel sheet quality | | | |
| | zone exit | heating | heating | Soaking | Steel | | | |
| Steel | temperature | zone | zone | zone | sheet | Nonplating | | |
| type | ° C. | ° C. | ° C. | ° C. | oxidation | defects | Alloying | Remarks |
| A | 550 | −40 | −25 | −30 | No | No | Pass | Invention |
| B | 600 | −15 | −15 | −15 | Yes | No | Pass | Comp. ex. |
| B | 550 | −35 | −20 | −22 | No | No | Pass | Invention |
| B | 650 | −28 | −25 | −22 | No | No | Pass | Invention |
| C | 600 | −30 | 5 | 5 | Yes | Yes | Fail | Comp. ex. |
| C | 600 | −35 | −25 | −25 | No | No | Pass | Invention |
| C | 500 | −40 | −40 | −40 | No | Yes | Fail | Comp. ex. |
| D | 700 | −25 | −10 | −10 | No | No | Pass | Invention |
| D | 600 | −35 | −20 | −25 | No | No | Pass | Invention |
| D | 400 | −30 | −15 | −15 | Yes | No | Pass | Comp. ex. |
| E | 780 | −30 | −20 | −20 | No | Yes | Fail | Comp. ex. |
| E | 650 | −30 | −20 | −20 | No | No | Pass | Invention |
| E | 720 | −35 | −5 | −5 | No | No | Pass | Invention |

1. A continuous annealing and hot dip plating method for steel sheet containing Si using an annealing furnace having, in order in a direction of conveyance of steel sheet, a front heating zone, rear heating zone, soaking zone, and cooling zone and a hot dip plating bath provided at a rear of the same so as to continuously convey steel sheet to the annealing furnace and hot dip plating bath and continuously anneal and hot dip plate it, said continuous annealing and hot dip plating method characterized by heating or soaking the steel sheet at a steel sheet temperature of a temperature range of at least 300° C. or more by indirect heating, making an atmosphere of the front heating zone, rear heating zone, soaking zone, and cooling zone one comprised of hydrogen in an amount of 1 to 10 vol % and a balance of nitrogen and unavoidable impurities, making a dew point of the front heating zone less than −25° C., making dew points of the rear heating zone and soaking zone −30° C. to 0° C., making a dew point of the cooling zone less than −25° C., annealing with a steel sheet peak temperature during heating in the front heating zone 550 to 750° C., then hot dip plating the sheet.

2. A continuous annealing and hot dip plating method for steel sheet containing Si as set forth in claim 1, characterized by exhausting at least part of the atmospheric gas flowing from said rear heating zone to said front heating zone side between said front heating zone and said rear heating zone.

3. A continuous annealing and hot dip plating method for steel sheet containing Si as set forth in claim 2, characterized by sealing the atmosphere between said front heating zone and said atmospheric gas exhaust location.

4. A continuous annealing and hot dip plating method for steel sheet containing Si as set forth in claim 1, characterized by sealing the atmosphere between said soaking zone and said cooling zone.

5. A continuous annealing and hot dip plating method for steel sheet containing Si as set forth in claim 1, characterized by wetting and introducing a mixed gas of nitrogen and hydrogen to said rear heating zone and/or said soaking zone.

6. A continuous annealing and hot dip plating method for steel sheet containing Si as set forth in claim 1, characterized by hot dip plating the steel sheet, then reheating it to 460° C. or more to cause the plating layer to alloy with the iron metal.

7. A continuous annealing and hot dip plating system for steel sheet containing Si provided with an annealing furnace and a hot dip plating bath, loading a continuous steel sheet from a front of an annealing furnace, moving it continuously inside the furnace to anneal it, then taking it out from the furnace and then continuously hot dip plating it by the hot dip plating bath at the rear of the annealing furnace, said continuous annealing and hot dip plating system characterized in that said annealing furnace is provided with, in a direction of conveyance of the steel sheet, zones divided into a front heating zone, a rear heating zone, a soaking zone, and a cooling zone, each zone is provided with rollers for conveying the steel sheet and openings for continuously conveying the steel sheet between the zones, each zone has means for controlling a composition of an atmospheric gas and a dew point of the atmosphere, the front heating zone, rear heating zone, and soaking zone have indirect heating type steel sheet heating means, the front heating zone and rear heating zone have between them an atmospheric gas exhausting means for exhausting to the outside of the furnace at least part of the atmospheric gas flowing in from the rear heating zone to the front heating zone, and the atmospheric gas exhausting means and the front heating zone and/or said soaking zone and said cooling zone have between them an atmospheric gas sealing system.

8. A continuous annealing and hot dip plating system for steel sheet containing Si as set forth in claim 7, characterized by being provided with an alloying furnace provided with a heating means for reheating the plated steel sheet at the rear of said hot dip plating bath.
